(19) United States
(12) Patent Application Publication
(10) Pub. No.: US 2013/0289202 A1
(43) Pub. Date: Oct. 31, 2013

(54) POLYAMIC ACID RESIN COMPOSITION AND METHOD OF PRODUCING THE SAME

(71) Applicants: Daichi Miyazaki, Otsu-shi (JP); Kazuto Miyoshi, Otsu-shi (JP); Masao Tomikawa, Otsu-shi (JP)

(72) Inventors: Daichi Miyazaki, Otsu-shi (JP); Kazuto Miyoshi, Otsu-shi (JP); Masao Tomikawa, Otsu-shi (JP)

(73) Assignee: TORAY INDUSTRIES, INC., Tokyo (JP)

(21) Appl. No.: 13/978,291

(22) PCT Filed: Dec. 21, 2011
(86) PCT No.: PCT/JP2011/079597

§ 371 Date: Jul. 3, 2013

(30) Foreign Application Priority Data
Jan. 7, 2011 (JP) 2011-001708

(51) Int. Cl. C08L 79/08; C08G 73/10

(52) U.S. Cl. CPC C08L 79/08; C08G 73/1042
USPC 524/600; 528/353

(57) ABSTRACT

The disclosed polyamic acid resin composition contains (a) a polyamic acid represented by general formula (1) or (2), and (b) a solvent. (A, A′, C, C′ are end-capped polyamic acid blocks comprising diaminobenzanilide and pyromellitic dianhydride or benzophenone tetracarboxylic dianhydride, and B, or D, is a polyamic acid block comprising a repeating unit other than A, A′, or C, C′.

A-B-A′ (1)

C-D-C′ (2)

### TECHNICAL FIELD

The present invention relates to a polyamic acid resin composition. More specifically, the present invention relates to a polyamic acid resin composition to be used suitably for, e.g., flexible substrates of a flat-panel display, electronic paper, a solar battery, and the like; a surface protective coat for a semiconductor device; a dielectric film among layers; an insulation layer or spacer layer of an organic electro-luminescence device (organic EL device); a planarization layer of a thin film transistor substrate; an insulation layer of an organic transistor; a flexible printed circuit board; and a binder for electrodes of a lithium ion secondary battery.

### BACKGROUND ART

Organic films are advantageous in that they are excellent in flexibility and less prone to rupture as compared with glass. Recently, there is an increasing move toward rendering displays more flexible by replacing the substrates of flat display panels from conventional glass to organic films.

In the event that a display is produced on an organic film, a process is common in which the organic film is formed on a substrate and the organic film is peeled off from the substrate after the production of a device. An organic film can be formed on a substrate by the following methods. One example is a method in which an organic film is stuck on a glass substrate with an adhesive (e.g., Patent Document 1). Alternatively, another example is a method in which a substrate is coated with a solution containing a resin as a raw material of a film and then the solution containing them is cured by heat or the like to form a film (e.g., Patent Document 2). The former needs to provide the adhesive between the substrate and the film and, therefore, the following process temperature may be limited by the thermal resistance of the adhesive. Conversely, the latter is advantageous in that no adhesive is used and that the film formed is low in surface roughness.

Examples of the resin to be used for an organic film include polyester, polyamide, polyimide, polycarbonate, polyethersulfone, acrylic resin, and epoxy resin. Of these, polyimide is suitable for a display substrate as a highly heat-resistant resin. When forming polyimide by the above-mentioned coating method, there is used a method in which a solution containing a polyamic acid as a precursor is coated and then cured, thereby being converted into polyimide.

Polyimides obtained by a combination of pyromellitic dianhydride or benzophenone tetracarboxylic dianhydride and diaminobenzanilides are known to have high thermal resistance, such as low coefficient of thermal expansion and high glass transition temperature (e.g., Patent Documents 3 and 4). When a polyimide has a low coefficient of thermal expansion, the difference from the coefficient of thermal expansion of a glass substrate (3 to 10 ppm/° C.) will become smaller and the warpage of a substrate produced in processing a polyimide into a film will be reduced. However, a solution of a polyamic acid, which is a precursor to such a polyimide, has a problem that the viscosity thereof decreases with time. Therefore, it is unsuitable to be used as the above-mentioned coating agent.

### PRIOR ART DOCUMENTS

### Patent Documents

Patent Document 1: Japanese Patent Laid-open Publication No. 2006-091822 (Claims 1, 2, and 7)
Patent Document 2: Japanese Patent Laid-open Publication (Translation of PCT Application) No. 2007-512568 (Claim 29)
Patent Document 3: Japanese Patent Laid-open Publication No. S62-81421 (Claims)
Patent Document 4: Japanese Patent Laid-open Publication No. H02-150453 (Claims)

### SUMMARY OF THE INVENTION

### Problems to be Solved by the Invention

In light of the above-described problems, an object of the present invention is to provide a polyamic acid resin composition which exhibits excellent storage stability and which can afford a thermally treated film having excellent thermal resistance.

### Solutions to the Problems

The present invention is a polyamic acid resin composition comprising (a) a polyamic acid represented by the general formula (1) or (2) and (b) one or some solvents,

### [Chemical Formula 1]

A-B-A′ (1)

[Chemical Formula 2]

C-D-C′ (2)

wherein in the general formula (1), A and A′ each represent a polyamic acid block represented by the general formula (3) one end of which has been capped; B represents a polyamic acid block represented by the general formula (4); in the general formula (2), C and C′ each represent a polyamic acid block represented by the general formula (5) one end of which has been capped; D represents a polyamic acid block represented by the general formula (6),

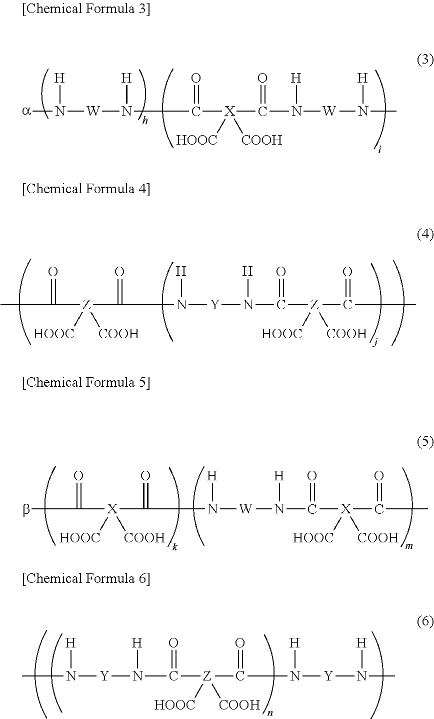

wherein in the general formulae (3) and (5), W is a divalent organic group having 2 or more carbon atoms and contains a divalent organic group represented by the general formula (7) as a main component; X is a tetravalent organic group having 2 or more carbon atoms and contains a tetravalent organic group represented by any one of the general formulae (8) and (9) as a main component; in the general formulae (4) and (6), Y represents a divalent organic group having 2 or more carbon atoms and Z represents a tetravalent organic group having 2 or more carbon atoms, provided that the polyamic acid blocks represented by the general formulae (4) and (6) each exclude polyamic acid blocks having a divalent organic group represented by the general formula (7) as Y and a tetravalent organic group represented by the general formula (8) or (9) as Z; α in the general formula (3) and β in the general formula (5) each represent a monovalent organic group having 1 to 20 carbon atoms; h and k each represent 0 or 1, and i, and n each represent a positive integer, where the blocks A and A′ may differ in h and in j, and the blocks C and C′ may differ in k and in m,

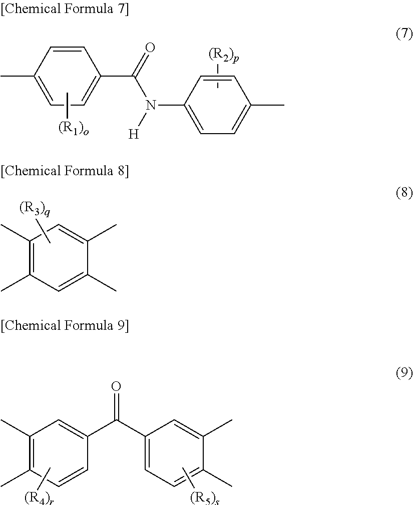

wherein R₁s to R₅s in the general formulae (7) to (9) each may be of a single type or of different types and each represent a monovalent organic group having 1 to 10 carbon atoms; o and p each represent an integer of 0 to 4, q represents an integer of 0 to 2, and r and s each represent an integer of 0 to 3.

### Effects of the Invention

According to the present invention, it is possible to obtain a polyamic acid resin composition which exhibits excellent storage stability and which can afford a thermally treated film having excellent thermal resistance.

### MODE FOR CARRYING OUT THE INVENTION

The polyamic acid resin composition of the present invention comprises (a) a polyamic acid represented by the general formula (1) or (2),

[Chemical Formula 10]

A-B-A′ (1)

[Chemical Formula 11]

C-D-C′ (2)

wherein in the general formula (1), A and A′ each represent a polyamic acid block represented by the general formula (3) one end of which has been capped; B represents a polyamic acid block represented by the general formula (4); in the general formula (2), C and C′ each represent a polyamic acid block represented by the general formula (5) one end of which has been capped; D represents a polyamic acid block represented by the general formula (6),

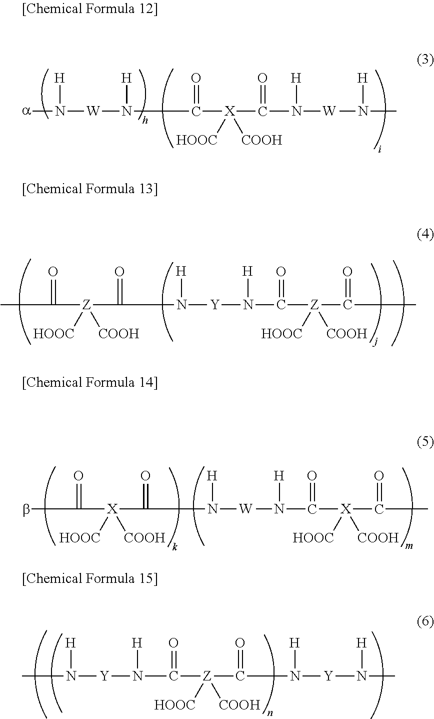

wherein in the general formulae (3) and (5), W is a divalent organic group having 2 or more carbon atoms and contains a divalent organic group represented by the general formula (7) as a main component; X is a tetravalent organic group having 2 or more carbon atoms and contains a tetravalent organic group represented by any one of the general formulae (8) and (9) as a main component; in the general formulae (4) and (6), Y represents a divalent organic group having 2 or more carbon atoms and Z represents a tetravalent organic group having 2 or more carbon atoms, provided that the polyamic acid blocks represented by the general formulae (4) and (6) each exclude polyamic acid blocks having a divalent organic group represented by the general formula (7) as Y and a tetravalent organic group represented by the general formula (8) or (9) as Z; α in the general formula (3) and β in the general formula (5) each represent a monovalent organic group having 1 to 20 carbon atoms; h and k each represent 0 or 1, and i, j, m, and n each represent a positive integer, where the blocks A and A′ may differ in h and in j, and the blocks C and C′ may differ in k and in m,

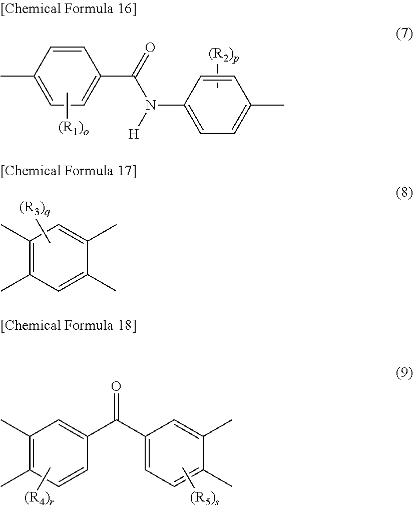

wherein R₁s to R₅s in the general formulae (7) to (9) each may be of a single type or of different types and each represent a monovalent organic group having 1 to 10 carbon atoms; o and p each represent an integer of 0 to 4, q represents an integer of 0 to 2, and r and s each represent an integer of 0 to 3.

A polyamic acid can be synthesized through a reaction of a diamine compound and an acid dianhydride as described below. W and Y in the general formulae (3) to (6) each represent a structural component of a diamine compound, and X and Z each represent a structural component of an acid dianhydride.

W in the general formulae (3) and (5) contains a divalent organic group represented by the general formula (7) as a main component. R₁ and R₂ each represent an organic group having 1 to 10 carbon atoms, specific examples thereof include hydrocarbon groups having 1 to 10 carbon atoms, alkoxy groups having 1 to 10 carbon atoms, and the foregoing groups with one or some hydrogen atoms having been substituted with halogen or the like. Examples of the diamine compounds capable of having such a configuration include 4,4′-diaminobenzanilide and its substituted derivatives. Out of these, 4,4′-diaminobenzanilide is preferred in terms of easy availability due to wide commercial availability. Such diamine compounds can be used singly or two or more of them can be used in combination. It is preferred to use as W the divalent organic group represented by the general formula (7) in a proportion of 50% or more. The proportion is more preferably 70% or more, and more preferably 90% or more. When the proportion of the divalent organic groups represented by the general formula (7) as Ws is less than 50%, high thermal resistance is not achieved.

X in the general formulae (3) and (5) contains a tetravalent organic group represented by any one of the general formulae (8) and (9) as a main component. R₃ to R₅ each represent an organic group having 1 to 10 carbon atoms, specific examples thereof include hydrocarbon groups having 1 to 10 carbon atoms, alkoxy groups having 1 to 10 carbon atoms, and the foregoing groups with one or some hydrogen atoms having been substituted with halogen or the like. Examples of the acid dianhydrides capable of having such a configuration include pyromellitic dianhydride, 3,3′,4,4′-benzophenonetetracarboxylic dianhydride, and substituted derivatives thereof. Out of these, pyromellitic dianhydride and 3,3′,4,4′-benzophenonetetracarboxylic dianhydride are preferred in terms of easy availability due to wide commercial availability. Such acid dianhydrides can be used singly or two or more of them can be used in combination. It is preferred to use as X the tetravalent organic group represented by any one of the general formulae (8) and (9) in a proportion of 50% or more. The proportion is more preferably 70% or more, and more preferably 90% or more. When the proportion of the tetravalent organic groups represented by any one of the general formulae (8) and (9) as Xs is less than 50%, high thermal resistance is not obtained.

Y in the general formulae (4) and (6) represents a divalent organic group having 2 or more carbon atoms. It should be noted that the polyamic acid blocks represented by the general formulae (4) and (6) each exclude polyamic acid blocks having a divalent organic group represented by the general formula (7) as Y and a tetravalent organic group represented by the general formula (8) or (9) as Z. The diamine compound capable of having such a configuration may be any diamine compound having no structure of the general formula (7). Examples thereof include 3,4′-diaminodiphenyl ether, 4,4′-diaminodiphenyl ether, 3,4′-diaminodiphenylmethane, 4,4′-diaminodiphenylmethane, 3,4′-diaminodiphenylsulfone, 4,4′-diaminodiphenylsulfone, 3,4′-diaminodiphenylsulfide, 4,4′-diaminodiphenylsulfide, 1,4-bis(4-aminophenoxy)benzene, benzidine, 2,2′-bis(trifluoromethyl)benzidine, 3,3′-bis(trifluoromethyl)benzidine, 2,2′-dimethylbenzidine, 3,3′-dimethylbenzidine, 2,2′,3,3′-tetramethylbenzidine, m-phenylenediamine, p-phenylenediamine, 1,5-naphthalenediamine, 2,6-naphthalenediamine, bis(4-aminophenoxyphenyl)sulfone, bis(3-aminophenoxyphenyl)sulfone, bis(4-aminophenoxy)biphenyl, bis{4-(4-aminophenoxy)phenyl}ether, 1,4-bis(4-aminophenoxy)benzene, or compounds in which the aromatic ring thereof has been substituted with one or some alkyl groups or halogen atoms, aliphatic cyclohexyldiamines, and methylenebiscyclohexylamines. Out of these, aromatic diamines are preferred in terms of thermal resistance. More preferred as Y is a diamine compound containing a divalent organic group represented by any one of the general formulae (11) and (12) as a main component. R₈ to R₁₀ each represent an organic group having 1 to 10 carbon atoms, specific examples thereof include hydrocarbon groups having 1 to 10 carbon atoms, alkoxy groups having 1 to 10 carbon atoms, and the foregoing groups with one or some hydrogen atoms having been substituted with halogen or the like. Examples of the diamine compounds capable of having such a configuration include m-phenylenediamine, p-phenylenediamine, benzidine, 2,2′-bis(trifluoromethyl)benzidine, 3,3′-bis(trifluoromethyl)benzidine, 2,2′-dimethylbenzidine, 3,3′-dimethylbenzidine, and 2,2′,3,3′-tetramethyl benzidine. Such diamine compounds can be used singly or two or more of them can be used in combination. It is preferable to use as Y a diamine compound containing a divalent organic group represented by any one of the general formulae (11) and (12) as a main component in a proportion of 50% or more. The proportion is more preferably 70% or more, and more preferably 90% or more.

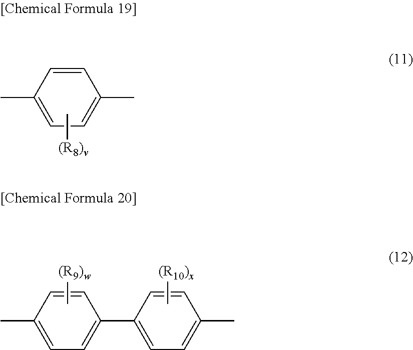

wherein in the general formulae (11) and (12), R₈s to R₁₀s each may be of a single type or of different types and each represent a monovalent organic group having 1 to 10 carbon atoms; and v, w, and x each represent an integer of 0 to 4.

On the other hand, Z in the general formulae (4) and (6) represents a tetravalent organic group having 2 or more carbon atoms. It should be noted that the polyamic acid blocks represented by the general formulae (4) and (6) each exclude polyamic acid blocks having a divalent organic group represented by the general formula (7) as Y and a tetravalent organic group represented by the general formula (8) or (9) as Z. The acid dianhydride capable of having such a configuration may be any acid dianhydride having no structures of the general formulae (8) and (9). Examples thereof can include aromatic tetracarboxylic dianhydrides such as 3,3′,4,4′-biphenyltetracarboxylic dianhydride, 2,3,3′,4′-biphenyltetracarboxylic dianhydride, 2,2′,3,3′-biphenyltetracarboxylic dianhydride, 2,2-bis(3,4-dicarboxyphenyl)propane dianhydride, 2,2-bis(2,3-dicarboxyphenyl)propane dianhydride, 1,1-bis(3,4-dicarboxyphenyl)ethane dianhydride, 1,1-bis(2,3-dicarboxyphenyl)ethane dianhydride, bis(3,4-dicarboxyphenyl)methane dianhydride, bis(2,3-dicarboxyphenyl)methane dianhydride, bis(3,4-dicarboxyphenyl)ether dianhydride, 2,2-bis(4-(4-aminophenoxy)phenyl)propane, 1,2,5,6-naphthalenetetracarboxylic dianhydride, 2,3,6,7-naphthalenetetracarboxylic dianhydride, 2,3,5,6-pyridinetetracarboxylic dianhydride, 3,4,9,10-perylenetetracarboxylic dianhydride, 2,2-bis(3,4-dicarboxyphenyl)hexafluoropropane dianhydride, 2,2-bis(4-(3,4-dicarboxyphenoxy)phenyl)hexafluoropropane dianhydride, 2,2-bis(4-(3,4-dicarboxybenzoyloxy)phenyl)hexafluoropropane dianhydride, 2,2′-bis(trifluoromethyl)-4,4′-bis(3,4-dicarboxyphenoxy)biphenyl dianhydride, and “RIKACID” (registered trademark) TMEG-100 (trade name, produced by New Japan Chemical Co., Ltd.); and aliphatic tetracarboxylic dianhydrides such as cyclobutanetetracarboxylic dianhydride, 1,2,3,4-cyclopentanetetracarboxylic dianhydride, 2,3,5,6-cyclohexanetetracarboxylic dianhydride, 5-(2,5-dioxotetrahydro-3-furanyl)-3-methyl-3-cyclohexene-1,2-dicarboxylic anhydride, and “RIKACID” (registered trademark) TDA-100, BT-100 (trade names, produced by New Japan Chemical Co., Ltd.). Out of these, aromatic acid dianhydrides are preferred in terms of thermal resistance. Acid dianhydrides mainly containing an organic group represented by the general formula (10) as a main component are more preferred as Z. R₆ and R₇ each represent an organic group having 1 to 10 carbon atoms, specific examples thereof include hydrocarbon groups having 1 to 10 carbon atoms, alkoxy groups having 1 to 10 carbon atoms, and the foregoing groups with one or some hydrogen atoms having been substituted with halogen or the like. Examples of the acid dianhydrides capable of having such a configuration include 3,3′,4,4′-biphenyltetracarboxylic dianhydride and substituted derivatives thereof. Out of these, 3,3′,4,4′-biphenyltetracarboxylic dianhydride is preferred in terms of easy availability due to wide commercial availability. Such acid dianhydrides can be used singly or two or more of them can be used in combination. It is preferred to use as Z an acid dianhydride containing a tetravalent organic group represented by the general formula (10) as a main component in a proportion of 50% or more. The proportion is more preferably 70% or more, and more preferably 90% or more.

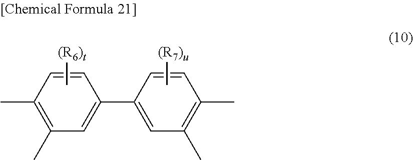

wherein in the general formula (10), R₆s and R₇s each may be of a single type or of different types and each represent a monovalent organic group having 1 to 10 carbon atoms; and t and u each represent an integer of 0 to 3.

In a solution of a polyamic acid, a reaction in which an amic acid moiety of the acid dissociates to form an acid anhydride group and an amino group and a reaction in which they recombine are in equilibrium. However, if the resulting acid anhydride group reacts with water present in the solution, it will turn into a dicarboxylic acid, so that it will become unable to recombine with an amine. Therefore, there is a tendency that the presence of water drives the equilibrium towards dissociation of the polyamic acid and the degree of polymerization of the polyamic acid lowers, and as a result the viscosity of the solution often lowers.

Especially, a polyamic acid obtained by causing a highly active acid dianhydride having a tetravalent organic group represented by any one of the general formulae (8) and (9) to react with a diamine having a divalent organic group represented by the general formula (7) allows a cured film to exhibit good thermal resistance, but the viscosity of a solution of the polyamic acid lowers greatly with time. On the other hand, a solution of a polyamic acid obtained by causing an acid dianhydride having low activity to react with a diamine having a divalent organic group represented by the general formula (7) is slow in progress with time of a decrease in viscosity. Therefore, the arrangement of polyamic acid blocks obtained by reacting a highly active acid dianhydride with a diamine having a divalent organic group represented by the general formula (7) at both ends of a polymer can prevent the molecular weight from decreasing greatly even if dissociation takes place. As a result, the polyamic acid solution can maintain its stable viscosity, so that the storage stability is improved.

The polyamic acid represented by the general formula (1) or (2) is a polyamic acid both ends of which have been capped with an end cap compound. In the general formula (3), α represents a constituent of an end cap compound of the polyamic acid represented by the general formula (1). In the general formula (5), β represents a constituent of an end cap compound of the polyamic acid represented by the general formula (2). When h=0 in the general formula (3), the end cap compound may be any one that reacts with an acid dianhydride to bond, and examples thereof include monoamines and monohydric alcohols. When h=1 in the general formula (3), the end cap compound may be any one that reacts with a diamine compound to bond, and examples thereof include acid anhydrides, monocarboxylic acids, monoacid chloride compounds, and mono-active ester compounds. On the other hand, when k=0 in the general formula (5), the end cap compound may be any one that reacts with a diamine compound to bond, and examples thereof include acid anhydrides, monocarboxylic acids, monoacid chloride compounds, and mono-active ester compounds. Moreover, when k=1 in the general formula (5), the end cap compound may be any one that reacts with an acid dianhydride to bond, and examples thereof include monoamines and monohydric alcohols. The use of an end cap compound is also preferable because it can adjust the molecular weight within a preferable range. Moreover, various organic groups can be introduced as an end group by reacting an end cap compound.

Examples of the monoamine to be used as the end cap compound include, but are not limited to, 5-amino-8-hydroxyquinoline, 4-amino-8-hydroxyquinoline, 1-hydroxy-8-aminonaphthalene, 1-hydroxy-7-aminonaphthalene, 1-hydroxy-6-aminonaphthalene, 1-hydroxy-5-aminonaphthalene, 1-hydroxy-4-aminonaphthalene, 1-hydroxy-3-aminonaphthalene, 1-hydroxy-2-aminonaphthalene, 1-amino-7-hydroxynaphthalene, 2-hydroxy-7-aminonaphthalene, 2-hydroxy-6-aminonaphthalene, 2-hydroxy-5-aminonaphthalene, 2-hydroxy-4-aminonaphthalene, 2-hydroxy-3-aminonaphthalene, 1-amino-2-hydroxynaphthalene, 1-carboxy-8-aminonaphthalene, 1-carboxy-7-aminonaphthalene, 1-carboxy-6-aminonaphthalene, 1-carboxy-5-aminonaphthalene, 1-carboxy-4-aminonaphthalene, 1-carboxy-3-aminonaphthalene, 1-carboxy-2-aminonaphthalene, 1-amino-7-carboxynaphthalene, 2-carboxy-7-aminonaphthalene, 2-carboxy-6-aminonaphthalene, 2-carboxy-5-aminonaphthalene, 2-carboxy-4-aminonaphthalene, 2-carboxy-3-aminonaphthalene, 1-amino-2-carboxynaphthalene, 2-aminonicotinic acid, 4-aminonicotinic acid, 5-aminonicotinic acid, 6-aminonicotinic acid, 4-aminosalicylic acid, 5-aminosalicylic acid, 6-aminosalicylic acid, 3-amino-O-toluic acid, ammelide, 2-aminobenzoic acid, 3-aminobenzoic acid, 4-aminobenzoic acid, 2-aminobenzenesulfonic acid, 3-aminobenzenesulfonic acid, 4-aminobenzenesulfonic acid, 3-amino-4,6-dihydroxypyrimidine, 2-aminophenol, 3-aminophenol, 4-aminophenol, 5-amino-8-mercaptoquinoline, 4-amino-8-mercaptoquinoline, 1-mercapto-8-aminonaphthalene, 1-mercapto-7-aminonaphthalene, 1-mercapto-6-aminonaphthalene, 1-mercapto-5-aminonaphthalene, 1-mercapto-4-aminonaphthalene, 1-mercapto-3-aminonaphthalene, 1-mercapto-2-aminonaphthalene, 1-amino-7-mercaptonaphthalene, 2-mercapto-7-aminonaphthalene, 2-mercapto-6-aminonaphthalene, 2-mercapto-5-aminonaphthalene, 2-mercapto-4-aminonaphthalene, 2-mercapto-3-aminonaphthalene, 1-amino-2-mercaptonaphthalene, 3-amino-4,6-dimercaptopyrimidine, 2-aminothiophenol, 3-aminothiophenol, 4-aminothiophenol, 2-ethynylaniline, 3-ethynylaniline, 4-ethynylaniline, 2,4-diethynylaniline, 2,5-diethynylaniline, 2,6-diethynylaniline, 3,4-diethynylaniline, 3,5-diethynylaniline, 1-ethynyl-2-aminonaphthalene, 1-ethynyl-3-aminonaphthalene, 1-ethynyl-4-aminonaphthalene, 1-ethynyl-5-aminonaphthalene, 1-ethynyl-6-aminonaphthalene, 1-ethynyl-7-aminonaphthalene, 1-ethynyl-8-aminonaphthalene, 2-ethynyl-1-aminonaphthalene, 2-ethynyl-3-aminonaphthalene, 2-ethynyl-4-aminonaphthalene, 2-ethynyl-5-aminonaphthalene, 2-ethynyl-6-aminonaphthalene, 2-ethynyl-7-aminonaphthalene, 2-ethynyl-8-aminonaphthalene, 3,5-diethynyl-1-aminonaphthalene, 3,5-diethynyl-2-aminonaphthalene, 3,6-diethynyl-1-aminonaphthalene, 3,6-diethynyl-2-aminonaphthalene, 3,7-diethynyl-1-aminonaphthalene, 3,7-diethynyl-2-aminonaphthalene, 4,8-diethynyl-1-aminonaphthalene, and 4,8-diethynyl-2-aminonaphthalene.

Preferred among these are 5-amino-8-hydroxyquinoline, 1-hydroxy-7-aminonaphthalene, 1-hydroxy-6-aminonaphthalene, 1-hydroxy-5-aminonaphthalene, 1-hydroxy-4-aminonaphthalene, 2-hydroxy-7-aminonaphthalene, 2-hydroxy-6-aminonaphthalene, 2-hydroxy-5-aminonaphthalene, 1-carboxy-7-aminonaphthalene, 1-carboxy-6-aminonaphthalene, 1-carboxy-5-aminonaphthalene, 2-carboxy-7-aminonaphthalene, 2-carboxy-6-aminonaphthalene, 2-carboxy-5-aminonaphthalene, 2-aminobenzoic acid, 3-aminobenzoic acid, 4-aminobenzoic acid, 4-aminosalicylic acid, 5-aminosalicylic acid, 6-aminosalicylic acid, 2-aminobenzenesulfonic acid, 3-aminobenzenesulfonic acid, 4-aminobenzenesulfonic acid, 3-amino-4,6-dihydroxypyrimidine, 2-aminophenol, 3-aminophenol, 4-aminophenol, 2-aminothiophenol, 3-aminothiophenol, 4-aminothiophenol, 3-ethynylaniline, 4-ethynylaniline, 3,4-diethynylaniline, and 3,5-diethynylaniline.

Examples of the monohydric alcohol to be used as the end cap compound include, but are not limited to, methanol, ethanol, 1-propanol, 2-propanol, 1-butanol, 2-butanol, 1-pentanol, 2-pentanol, 3-pentanol, 1-hexanol, 2-hexanol, 3-hexanol, 1-heptanol, 2-heptanol, 3-heptanol, 1-octanol, 2-octanol, 3-octanol, 1-nonanol, 2-nonanol, 1-decanol, 2-decanol, 1-undecanol, 2-undecanol, 1-dodecanol, 2-dodecanol, 1-tridecanol, 2-tridecanol, 1-tetradecanol, 2-tetradecanol, 1-pentadecanol, 2-pentadecanol, 1-hexadecanol, 2-hexadecanol, 1-heptadecanol, 2-heptadecanol, 1-octadecanol, 2-octadecanol, 1-nonadecanol, 2-nonadecanol, 1-icosanol, 2-methyl-1-propanol, 2-methyl-2-propanol, 2-methyl-1-butanol, 3-methyl-1-butanol, 2-methyl-2-butanol, 3-methyl-2-butanol, 2-propyl-1-pentanol, 2-ethyl-1-hexanol, 4-methyl-3-heptanol, 6-methyl-2-heptanol, 2,4,4-trimethyl-1-hexanol, 2,6-dimethyl-4-heptanol, isononyl alcohol, 3,7-dimethyl-3-octanol, 2,4-dimethyl-1-heptanol, 2-heptylundecanol, ethylene glycol monoethyl ether, ethylene glycol monomethyl ether, ethylene glycol monobutyl ether, propylene glycol 1-methyl ether, diethylene glycol monoethyl ether, diethylene glycol monomethyl ether, diethylene glycol monobutyl ether cyclopentanol, cyclohexanol, cyclopentane monomethylol, dicyclopentane monomethylol, tricyclodecane monomethylol, norborneol, and terpineol.

Preferred among these are primary alcohols in terms of reactivity with an acid dianhydride.

Examples of the acid anhydride, monocarboxylic acid, monoacid chloride compound, and mono-active ester compound to be used as the end cap compound include acid anhydrides such as phthalic anhydride, maleic anhydride, nasic anhydride, cyclohexane dicarboxylic anhydride, and 3-hydroxyphthalic acid anhydride; monocarboxylic acids such as 2-carboxyphenol, 3-carboxyphenol, 4-carboxyphenol, 2-carboxythiophenol, 3-carboxythiophenol, 4-carboxythiophenol, 1-hydroxy-8-carboxynaphthalene, 1-hydroxy-7-carboxynaphthalene, 1-hydroxy-6-carboxynaphthalene, 1-hydroxy-5-carboxynaphthalene, 1-hydroxy-4-carboxynaphthalene, 1-hydroxy-3-carboxynaphthalene, 1-hydroxy-2-carboxynaphthalene, 1-mercapto-8-carboxynaphthalene, 1-mercapto-7-carboxynaphthalene, 1-mercapto-6-carboxynaphthalene, 1-mercapto-5-carboxynaphthalene, 1-mercapto-4-carboxynaphthalene, 1-mercapto-3-carboxynaphthalene, 1-mercapto-2-carboxynaphthalene, 2-carboxybenzenesulfonic acid, 3-carboxybenzenesulfonic acid, 4-carboxybenzenesulfonic acid, 2-ethynylbenzoic acid, 3-ethynylbenzoic acid, 4-ethynylbenzoic acid, 2,4-diethynylbenzoic acid, 2,5-diethynylbenzoic acid, 2,6-diethynylbenzoic acid, 3,4-diethynylbenzoic acid, 3,5-diethynylbenzoic acid, 2-ethynyl-1-naphthoic acid, 3-ethynyl-1-naphthoic acid, 4-ethynyl-1-naphthoic acid, 5-ethynyl-1-naphthoic acid, 6-ethynyl-1-naphthoic acid, 7-ethynyl-1-naphthoic acid, 8-ethynyl-1-naphthoic acid, 2-ethynyl-2-naphthoic acid, 3-ethynyl-2-naphthoic acid, 4-ethynyl-2-naphthoic acid, 5-ethynyl-2-naphthoic acid, 6-ethynyl-2-naphthoic acid, 7-ethynyl-2-naphthoic acid, and 8-ethynyl-2-naphthoic acid, and monoacid chloride compounds each resulting from the conversion into an acid chloride from the carboxylic acid group of each of the foregoing; monoacid chloride compounds each resulting from the conversion into an acid chloride from only a monocarboxyl group of dicarboxylic acids such as terephthalic acid, phthalic acid, maleic acid, cyclohexanedicarboxylic acid, 3-hydroxyphthalic acid, 5-norbornene-2,3-dicarboxylic acid, 1,2-dicarboxynaphthalene, 1,3-dicarboxynaphthalene, 1,4-dicarboxynaphthalene, 1,5-dicarboxynaphthalene, 1,6-dicarboxynaphthalene, 1,7-dicarboxynaphthalene, 1,8-dicarboxynaphthalene, 2,3-dicarboxynaphthalene, 2,6-dicarboxynaphthalene, and 2,7-dicarboxynaphthalene; and active ester compounds obtained by a reaction of a monoacid chloride compound with N-hydroxybenzotriazole or N-hydroxy-5-norbornene-2,3-dicarboximide.

Preferred among these are acid anhydrides such as phthalic anhydride, maleic anhydride, nasic anhydride, cyclohexane dicarboxylic anhydride, and 3-hydroxyphthalic acid anhydride; monocarboxylic acids such as 3-carboxyphenol, 4-carboxyphenol, 3-carboxythiophenol, 4-carboxythiophenol, 1-hydroxy-7-carboxynaphthalene, 1-hydroxy-6-carboxynaphthalene, 1-hydroxy-5-carboxynaphthalene, 1-mercapto-7-carboxynaphthalene, 1-mercapto-6-carboxynaphthalene, 1-mercapto-5-carboxynaphthalene, 3-carboxybenzenesulfonic acid, 4-carboxybenzenesulfonic acid, 3-ethynylbenzoic acid, 4-ethynylbenzoic acid, 3,4-diethynylbenzoic acid, and 3,5-diethynylbenzoic acid, and monoacid chloride compounds each resulting from the conversion into an acid chloride from the carboxylic acid group of each of the foregoing; monoacid chloride compounds each resulting from the conversion into an acid chloride from only a monocarboxyl group of dicarboxylic acids such as terephthalic acid, phthalic acid, maleic acid, cyclohexanedicarboxylic acid, 1,5-dicarboxynaphthalene, 1,6-dicarboxynaphthalene, 1,7-dicarboxynaphthalene, and 2,6-dicarboxynaphthalene; and active ester compounds obtained by a reaction of a monoacid chloride compound with N-hydroxybenzotriazole or N-hydroxy-5-norbornene-2,3-dicarboximide.

The introduction ratio of the monoamine to be used as an end cap compound is preferably within the range of 0.1 to 60 mol %, particularly preferably 5 to 50 mol % based on all amine components. The introduction ratio of the acid anhydride, monocarboxylic acid, monoacid chloride compound, and mono-active ester compound to be used as an end cap compound is preferably within the range of 0.1 to 100 mol %, particularly preferably 5 to 90 mol % based on the diamine component. It is permissible to introduce two or more different end groups by causing two or more end cap compounds to react with each other.

The end cap compound having been introduced into a polyamic acid can be detected easily by the following method. For example, an end cap compound can be detected easily by dissolving a polymer into which the end cap compound has been introduced in an acidic solution to decompose the polymer into an amine component and an acid anhydride component which are structural units of the polymer, and then measuring them by gas chromatography (GC) or NMR. Alternatively, a polymer into which an end cap compound has been introduced is directly subjected to the measurement of a thermal decomposition gas chromatograph (PGC), an infrared spectrum, or C¹³ NMR spectrum, so that the end cap compound can be detected easily.

i in the general formula (3) represents the number of repetition of the structural units contained in blocks A and A′, and j in the general formula (4) represents the number of repetition of the structural units contained in block B. i and j each represent a positive integer and it is preferred that j/i≧0.5. More preferably j/i≧1, and even more preferably j/i≧2. If j/i≧0.5, the molecular weight can be prevented from decreasing greatly even if dissociation takes place at blocks A and A′. As a result, the polyamic acid solution can maintain its stable viscosity, so that the storage stability is improved.

On the other hand, m in the general formula (5) represents the number of repetition of the structural units contained in blocks C and C′, and n in the general formula (6) represents the number of repetition of the structural units contained in block D. m and n each represent a positive integer and it is preferred that n/m≧0.5. More preferably n/m≧1, and even more preferably n/m≧2. If n/n≧0.5, the molecular weight can be prevented from decreasing greatly even if dissociation takes place at blocks C and C′. As a result, the polyamic acid solution can maintain its stable viscosity, so that the storage stability is improved.

The weight average molecular weight of the polyamic acid represented by the general formula (1) or (2), which is determined in polystyrene equivalent by gel permeation chromatography, is preferably 2,000 or more, more preferably 3,000 or more, and even more preferably 5,000 or more, and it is preferably 200,000 or less, more preferably 100,000 or less, and even more preferably 50,000 or less. When the weight average molecular weight is 2,000 or more, the thermal resistance and mechanical strength of a cured film become better. In the case of being 200,000 or less, it is possible to inhibit the viscosity of the polyamic acid resin composition from increasing when the resin is dissolved at a high concentration in a solvent.

The polyamic acid resin composition of the present invention comprises (b) one or some solvents. Polar aprotic solvents such as N-methyl-2-pyrrolidone, γ-butyrolactone, N,N-dimethylformamide, N,N-dimethylacetamide, and dimethyl sulfoxide, ethers such as tetrahydrofuran, dioxane, and propylene glycol monomethyl ether, ketones such as acetone, methyl ethyl ketone, diisobutyl ketone, and diacetone alcohol, esters such as ethyl acetate, propylene glycol monomethyl ether acetate, and ethyl lactate, and aromatic hydrocarbons such as toluene and xylene may be used singly as the solvent, or two or more of them may be used in combination.

The content of the solvent per 100 parts by weight of the polyamic acid represented by the general formula (1) or (2) is preferably 50 parts by weight or more, and more preferably 100 parts by weight or more, and it is preferably 2,000 parts by weight or less, and more preferably 1,500 parts by weight or less. When the content is within the range of 50 to 2,000 parts by weight, a viscosity suitable for coating is afforded and the film thickness after coating can be controlled easily.

In order to further improve the thermal resistance, the resin composition of the present invention may comprise (c) inorganic particles. Examples thereof include metal inorganic particles such as platinum, gold, palladium, silver, copper, nickel, zinc, aluminum, iron, cobalt, rhodium, ruthenium, tin, lead, bismuth, and tungsten, and metal oxide inorganic particles such as silicon oxide (silica), titanium oxide, aluminum oxide, zinc oxide, tin oxide, tungsten oxide, calcium carbonate, and barium sulfate. The shape of the (c) inorganic particle is not particularly restricted and examples thereof include a spherical shape, an elliptical shape, a flat shape, a rod shape, and a fibrous shape. In order to suppress an increase in surface roughness of a cured film of the resin composition comprising the (c) inorganic particles, the average particle diameter of the (c) inorganic particles is preferably small. The range of a preferable average particle diameter is 1 nm or more and 100 nm or less, more preferably 1 nm or more and 50 nm or less, and even more preferably 1 nm or more and 30 nm or less.

The content of the (c) inorganic particles is preferably 3 parts by weight or more, more preferably 5 parts by weight or more, and even more preferably 10 parts by weight or more, and preferably 100 parts by weight or less, more preferably 80 parts by weight or less, and even more preferably 50 parts by weight or less per 100 parts by weight of the (a) polyamic acid represented by the general formula (1) or (2). If the content of the (c) inorganic particles is 3 parts by weight or more, thermal resistance improves enough, whereas if the content is 100 parts by weight or less, the toughness of the cured film is less prone to deteriorate.

Various known methods can be used as a method for causing the (c) inorganic particles to be contained. Examples thereof include methods in which an organo inorganic particle sol is caused to be contained. An organo inorganic particle sol is a material prepared by dispersing inorganic particles in an organic solvent. Examples of the organic solvent include methanol, isopropanol, normal butanol, ethylene glycol, methyl ethyl ketone, methyl isobutyl ketone, propylene glycol monomethyl ether acetate, propylene glycol monomethyl ether, N,N-dimethylacetamide, N,N-dimethylformamide, N-methyl-2-pyrrolidone, 1,3-dimethylimidazolidinone, and γ-butyrolactone.

The (c) inorganic particles may be particles having been subjected to surface treatment. Examples of the method of the surface treatment for the (c) inorganic particles include a method comprising treating an organo inorganic particle sol with a silane coupling agent. Various known methods can be used as a specific treating method; one example is a method in which a silane coupling agent is added to an organo inorganic particle sol, followed by stirring at room temperature to 80° C. for 0.5 to 2 hours.

The polyamic acid resin composition of the present invention can contain one or some surfactants in order to improve its wettability with a substrate. Examples of the surfactant include fluorine-based surfactants such as Fluorad (commercial name, produced by Sumitomo 3M Limited), Megaface (commercial name, produced by DIC Corporation), and Surflon (commercial name, produced by Asahi Glass Co., Ltd.). Examples thereof further include organic siloxane surfactants such as KP341 (commercial name, produced by Shin-Etsu Chemical Co., Ltd.), DBE (commercial name, produced by Chisso Corporation), Polyflow, Glanol (commercial names, produced by Kyoeisha Chemical Co., Ltd.), and BYK (produced by BYK-Chemie GmbH). Examples thereof still further include acrylic polymer surfactants such as Polyflow (commercial name, produced by Kyoeisha Chemical Co., Ltd.).

The surfactant is preferably contained in an amount of 0.01 to 10 parts by weight per 100 parts by weight of the polyamic acid represented by the general formula (1) or (2).

Next, a method for producing the polyamic acid represented by the general formula (1) or (2) will be described. For example, the polyamic acid represented by the general formula (1) can be obtained by reacting 1.00 to 2 molar equivalents of a diamine compound represented by the general formula (14) and 0.01 to 1 molar equivalent of an end cap compound with 1 molar equivalent of an acid dianhydride represented by the general formula (13), and then adding a diamine compound represented by the general formula (15) and an acid dianhydride represented by the general formula (16) in an amount of 1.01 to 2 molar equivalents to 1 molar equivalent of the diamine compound represented by the general formula (15) to react them. At this time, a compound other than compounds having Y containing a divalent organic group represented by the general formula (7) is used as the diamine compound represented by the general formula (15) or a compound other than compounds having Z containing a tetravalent organic group represented by any one of the general formulae (8) and (9) is used as the acid dianhydride represented by the general formula (16).

The amount of the diamine represented by the general formula (14) per 1 molar equivalent of the acid dianhydride represented by the general formula (13) is preferably 1.00 to 1.5 molar equivalents, and more preferably 1.00 to 1.3 molar equivalents. Moreover, the amount of the end cap compound per 1 molar equivalent of the acid dianhydride represented by the general formula (13) is preferably 0.02 to 0.5 molar equivalents, and more preferably 0.05 to 0.2 molar equivalents. The amount of the acid dianhydride represented by the general formula (16) per 1 molar equivalent of the diamine represented by the general formula (15) is preferably 1.02 to 1.5 molar equivalents, and more preferably 1.05 to 1.3 molar equivalents.

Moreover, the amount of the diamine represented by the general formula (15) per 1 molar equivalent of the acid dianhydride represented by the general formula (13) is preferably 0.5 molar equivalents or more, more preferably 1 molar equivalent or more, and even more preferably 2 molar equivalents or more. If it is 0.5 molar equivalents or more, the molecular weight can be prevented from decreasing greatly even if dissociation takes place at blocks A and A′. As a result, the polyamic acid solution can maintain its stable viscosity, so that the storage stability is improved.

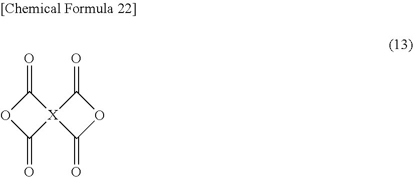

wherein in the general formula (13), X is a tetravalent organic group having 2 or more carbon atoms and contains a tetravalent organic group represented by any one of the general formulae (8) and (9) as a main component,

[Chemical Formula 23]

H₂N—W—NH₂ (14)

wherein in formula (14), W is a divalent organic group having 2 or more carbon atoms and contains a divalent organic group represented by the general formula (7) as a main component,

[Chemical Formula 24]

H₂N—Y—NH₂ (15)

wherein in the general formula (15), Y represents a divalent organic group having 2 or more carbon atoms,

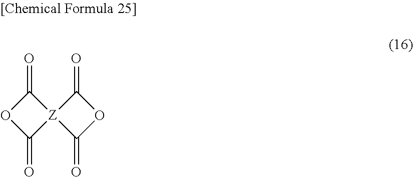

wherein in the general formula (16), Z represents a tetravalent organic group having 2 or more carbon atoms.

Alternatively, the polyamic acid represented by the general formula (1) can be obtained by preparing separately a material resulting from reacting 1.00 to 2 molar equivalents of a diamine compound represented by the general formula (14) and 0.01 to 1 molar equivalent of an end cap compound with 1 molar equivalent of an acid dianhydride represented by the general formula (13), and a material resulting from reacting 1.01 to 2 molar equivalents of a acid dianhydride represented by the general formula (16) with 1 molar equivalent of a diamine compound represented by the general formula (15), and then mixing both the materials to react with each other. At this time, a compound other than compounds having Y containing a divalent organic group represented by the general formula (7) is used as the diamine compound represented by the general formula (15) or a compound other than compounds having Z containing a tetravalent organic group represented by any one of the general formulae (8) and (9) is used as the acid dianhydride represented by the general formula (16).

The amount of the diamine compound represented by the general formula (14) per 1 molar equivalent of the acid dianhydride represented by the general formula (13) is preferably 1.00 to 1:5 molar equivalents, and more preferably 1.00 to 1.3 molar equivalents. Moreover, the amount of the end cap compound per 1 molar equivalent of the acid dianhydride represented by the general formula (13) is preferably 0.02 to 0.5 molar equivalents, and more preferably 0.05 to 0.2 molar equivalents. The amount of the acid dianhydride represented by the general formula (16) per 1 molar equivalent of the diamine represented by the general formula (15) is preferably 1.02 to 1.5 molar equivalents, and more preferably 1.05 to 1.3 molar equivalents.

Moreover, the amount of the diamine represented by the general formula (15) per 1 molar equivalent of the acid dianhydride represented by the general formula (13) is preferably 0.5 molar equivalents or more, more preferably 1 molar equivalent or more, and even more preferably 2 molar equivalents or more. If it is 0.5 molar equivalents or more, the molecular weight can be prevented from decreasing greatly even if dissociation takes place at blocks A and A′. As a result, the polyamic acid solution can maintain its stable viscosity, so that the storage stability is improved.

On the other hand, the polyamic acid represented by the general formula (2) can be obtained by reacting 1.00 to 2 molar equivalents of an acid dianhydride represented by the general formula (13) and 0.01 to 1 molar equivalent of an end cap compound with 1 molar equivalent of a diamine compound represented by the general formula (14), and then adding an acid dianhydride represented by the general formula (16) and a diamine compound represented by the general formula (15) in an amount of 1.01 to 2 molar equivalents to 1 molar equivalent of the acid anhydride represented by the general formula (16) to react them. At this time, a compound other than compounds having Y containing a divalent organic group represented by the general formula (7) is used as the diamine compound represented by the general formula (15) or a compound other than compounds having Z containing a tetravalent organic group represented by any one of the general formulae (8) and (9) is used as the acid dianhydride represented by the general formula (16).

The amount of the acid dianhydride represented by the general formula (13) per 1 molar equivalent of the diamine compound represented by the general formula (14) is preferably 1.00 to 1.5 molar equivalents, and more preferably 1.00 to 1.3 molar equivalents. Moreover, the amount of the end cap compound per 1 molar equivalent of the diamine compound represented by the general formula (14) is preferably 0.02 to 0.5 molar equivalents, and more preferably 0.05 to 0.2 molar equivalents. Moreover, the amount of the diamine compound represented by the general formula (15) per 1 molar equivalent of the acid dianhydride represented by the general formula (16) is preferably 1.02 to 1.5 molar equivalents, and more preferably 1.05 to 1.3 molar equivalents.

Moreover, the amount of the acid dianhydride represented by the general formula (16) per 1 molar equivalent of the diamine represented by the general formula (14) is preferably 0.5 molar equivalents or more, more preferably 1 molar equivalent or more, and even more preferably 2 molar equivalents or more. If it is 0.5 molar equivalents or more, the molecular weight can be prevented from decreasing greatly even if dissociation takes place at blocks C and C′. As a result, the polyamic acid solution can maintain its stable viscosity, so that the storage stability is improved.

The polyamic acid represented by the general formula (2) can be obtained by preparing separately a material resulting from reacting 1.00 to 2 molar equivalents of an acid dianhydride represented by the general formula (13) and 0.01 to 1 molar equivalent of an end cap compound with 1 molar equivalent of a diamine compound represented by the general formula (14), and a material resulting from adding 1.01 to 2 molar equivalents of a diamine compound represented by the general formula (15) to 1 molar equivalent of a acid dianhydride represented by the general formula (16) to react with each other, and then mixing both the materials to react them. At this time, a compound other than compounds having Y containing a divalent organic group represented by the general formula (7) is used as the diamine compound represented by the general formula (15) or a compound other than compounds having Z containing a tetravalent organic group represented by any one of the general formulae (8) and (9) is used as the acid dianhydride represented by the general formula (16).

The amount of the acid dianhydride represented by the general formula (13) per 1 molar equivalent of the diamine compound represented by the general formula (14) is preferably 1.00 to 1.5 molar equivalents, and more preferably 1.00 to 1.3 molar equivalents. Moreover, the amount of the end cap compound per 1 molar equivalent of the diamine compound represented by the general formula (14) is preferably 0.02 to 0.5 molar equivalents, and more preferably 0.05 to 0.2 molar equivalents. Moreover, the amount of the diamine compound represented by the general formula (15) per 1 molar equivalent of the acid dianhydride represented by the general formula (16) is preferably 1.02 to 1.5 molar equivalents, and more preferably 1.05 to 1.3 molar equivalents.

Moreover, the amount of the acid dianhydride represented by the general formula (16) per 1 molar equivalent of the diamine compound represented by the general formula (14) is preferably 0.5 molar equivalents or more, more preferably 1 molar equivalent or more, and even more preferably 2 molar equivalents or more. If it is 0.5 molar equivalents or more, the molecular weight can be prevented from decreasing greatly even if dissociation takes place at blocks C and C′. As a result, the polyamic acid solution can maintain its stable viscosity, so that the storage stability is improved.

In these production methods, it is preferable that the number of moles of the amino groups and acid anhydride groups contained in the acid dianhydride represented by the general formula (13), the diamine compound represented by the general formula (14), the diamine compound represented by the general formula (15), the acid dianhydride represented by the general formula (16), and the end cap compound are the same. Polar aprotic solvents such as N-methyl-2-pyrrolidone, γ-butyrolactone, N,N-dimethylformamide, N,N-dimethylacetamide, and dimethyl sulfoxide, ethers such as tetrahydrofuran, dioxane, and propylene glycol monomethyl ether, ketones such as acetone, methyl ethyl ketone, diisobutyl ketone, and diacetone alcohol, esters such as ethyl acetate, propylene glycol monomethyl ether acetate, and ethyl lactate, and aromatic hydrocarbons such as toluene and xylene may be used singly as a reaction solvent, or two or more of them may be used in combination. Moreover, the use of the same solvent as the (b) solvent contained in the polyamic acid resin composition of the present invention can afford a desired polyamic acid resin composition without isolating a resin after the production.

Next, a method for producing a heat-resistant resin film using the polyamic acid resin composition of the present invention will be described.

First, the polyamic acid resin composition is coated onto a substrate. Examples of the substrate to be used include, but are not limited to, silicon wafer, ceramics, gallium arsenic, soda lime glass, and non-alkali glass. Examples of the coating method include slit die coating method, spin coating method, spray coating method, roll coating method, and bar coating method; the coating may be performed by using these methods in combination.

Then, the substrate onto which the polyamic acid resin composition is coated is dried to afford a polyamic acid resin composition film. The drying is performed by using a hot plate, an oven, infrared rays, a vacuum chamber, or the like. In the case of using a hot plate, an object to be heated is heated while being held on the plate directly or on a jig such as a proximity pin disposed on the plate. Examples of the material of the proximity pin include metallic materials such as aluminum and stainless steel and synthetic resins such as polyimide resin and “TEFLON” (registered trademark), and proximity pins made of any material may be used. The height of the proximity pin varies depending upon the size of the substrate, the type of the resin layer as an object to be heated, the purpose of heating, and on the like; for example, when a resin layer formed on a glass substrate measuring 300 mm×350 mm×0.7 mm is heated, the height of the proximity pin is preferably about 2 mm to about 12 mm. Although the heating temperature varies depending upon the type of an object to be heated and the purpose of heating, the heating is preferably performed at a temperature within the range of room temperature to 180° C. for one minute to several hours.

Then, a temperature is applied at within the range of 180° C. or higher and 500° C. or lower, so that the resin layer is converted into a heat-resistant resin film. While examples of the method of peeling off the heat-resistant resin film from the substrate include a method comprising immersion in a chemical liquid such as fluoric acid and a method comprising irradiating the interface between the heat-resistant resin film and the substrate with a laser, any method may be used.

### EXAMPLES

The present invention will be described below with reference to Examples and the like, but the invention is not limited to these examples.

### (1) Viscosity Measurement

Measurement was performed at 25° C. using a viscometer (TVE-22H manufactured by Toki Sangyo Co., Ltd.).

### (2) Measurement of Weight Average Molecular Weight

A weight average molecular weight was determined in polystyrene equivalent by gel permeation chromatography (Waters 2690 manufactured by Waters Corporation). The columns used were TOSOH TXK-GEL α-2500 and α-4000 produced by Tosoh Corporation, and the mobile layer used was NMP.

### (3) Test Method for Storage Stability Evaluation

A polyamic acid resin composition (henceforth referred to as varnish) prepared in Example was adjusted using NMP so as to have a viscosity of 2850 to 3150 mPa·s. After the viscosity adjustment, a test was performed at 40° C. for 24 hours in a thermostatic chamber (Cool incubator PCI-301 manufactured by AS ONE Corporation). (Henceforth, a sample before the execution of this test is referred to as “before test” and a sample after the execution of the test is referred to as “after test”)

### (4) Calculation of Viscosity Change Factor

The viscosity of a varnish after a storage stability evaluation test was measured, and then a change factor was calculated using the following formula.

Change factor (%)=[(viscosity before test)−(viscosity after test)]/(viscosity before test)×100

### (5) Calculation of Weight Average Molecular Weight Change Factor

The weight average molecular weight of a varnish after a storage stability evaluation test was measured, and then a change factor was calculated using the following formula.

Change factor (%)=[(weight average molecular weight before test)−(weight average molecular weight after test)]/(weight average molecular weight before test)×100

### (6-1) Preparation of Heat-Resistant Resin Film (Examples 1 to 12, Comparative Examples 1 to 11)

A varnish synthesized in Example was filtered under pressure using a 1-μm filter, thereby removing foreign matters. The filtered varnish was coated onto a 4-inch silicon wafer and subsequently was prebaked at 150° C. for 3 minutes by using a hot plate (D-Spin manufactured by Dainippon Screen Mfg. Co., Ltd.), thereby affording a prebaked film. The thickness of the film was adjusted so that it might be 10 μm after curing. The prebaked film was heat-treated at 350° C. for 30 minutes under nitrogen flow (with an oxygen concentration of 20 pm or less) by using an Inert Gas Oven (INH-21CD manufactured by Koyo Thermo Systems Co., Ltd.), thereby preparing a heat-resistant resin. Subsequently, after immersion in fluoric acid for 4 minutes, the heat-resistant resin film was peeled off from the substrate and then air-dried.

### (6-2) Preparation of Heat-Resistant Resin Film (Example 13, Comparative Example 12)

A heat-resistant resin film was prepared in the same manner as in (6-1) except for coating a varnish onto a 4-inch silicon wafer sputtered with aluminum instead of coating a varnish onto a 4-inch silicon wafer, and performing peeling from a substrate after immersion into hydrochloric acid instead of fluoric acid.

### (7) Measurement of Glass Transition Temperature (Tg)

Measurement was performed by using a thermomechanical analyzer (EXSTAR6000 TMA/SS6000 manufactured by SII NanoTechnology Inc.) under nitrogen flow. The rising of temperature was performed under the following conditions. The temperature was raised up to 150° C. in the first stage, thereby removing the adsorbed water of the sample, and then the temperature was lowered to room temperature in the second stage. In the third stage, the plenary measurement was performed at a temperature rising rate of 5° C./minute, thereby measuring a glass transition temperature.

### (8) Measurement of Coefficient of Thermal Expansion (CTE)

Measurement was performed in the same manner as in the measurement of glass transition temperature, and then the average of coefficients of thermal expansion at 50 to 200° C. was calculated.

### (9) Measurement of Temperature of 5% Weight Loss (Td5)

Measurement was performed by using a thermogravimetric analyzer (TGA-50 manufactured by Shimadzu Corporation) under nitrogen flow. The rising of temperature was performed under the following conditions. The temperature was raised up to 150° C. in the first stage, thereby removing the adsorbed water of the sample, and then the temperature was lowered to room temperature in the second stage. In the third stage, the plenary measurement was performed at a temperature rising rate of 10° C./minute, thereby measuring a temperature of 5% heat weight loss.

The abbreviations of the compounds used in Examples are as follows.

DABA: 4,4′-diaminobenzanilide
PDA: p-phenylenediamine
TFMB: 2,2′-bis(trifluoromethyl)benzidine,
DAE: 4,4′-diaminodiphenylether
PMDA: pyromellitic dianhydride
BTDA: 3,3′,4,4′-benzophenonetetracarboxylic dianhydride
BPDA: 3,3′,4,4′-biphenyltetracarboxylic dianhydride
ODPA: bis(3,4-dicarboxyphenyl)ether dianhydride
MAP: 3-aminophenol
EtOH: ethanol
PA: phthalic anhydride
NMP: N-methyl-2-pyrrolidone

### Example 1

Under a dry nitrogen gas flow, 3.054 g (14 mmol) of PMDA, 3.182 g (14 mmol) of DABA, 0.218 g (2 mmol) of MAP, and 30 g of NMP were charged into a 100-mL four-neck flask, and then heated and stirred at 50° C. One hour later, 1.765 g (6 mmol) of BPDA and 1.136 g (5 mmol) of DABA were added, followed by heating and stirring. Two hours later, cooling afforded a varnish.

### Example 2

Under a dry nitrogen gas flow, 3.054 g (14 mmol) of PMDA, 3.182 g (14 mmol) of DABA, 0.218 g (2 mmol) of MAP, and 30 g of NMP were charged into a 100-mL four-neck flask, and then heated and stirred at 50° C. One hour later, 1.861 g (6 mmol) of ODPA and 1.136 g (5 mmol) of DABA were added, followed by heating and stirring. Two hours later, cooling afforded a varnish.

### Example 3

Under a dry nitrogen gas flow, 3.054 g (14 mmol) of PMDA, 3.182 g (14 mmol) of DABA, 0.218 g (2 mmol) of MAP, and 30 g of NMP were charged into a 100-mL four-neck flask, and then heated and stirred at 50° C. One hour later, 1.309 g (6 mmol) of PMDA and 0.541 g (5 mmol) of PDA were added, followed by heating and stirring. Two hours later, cooling afforded a varnish.

### Example 4

Under a dry nitrogen gas flow, 3.054 g (14 mmol) of PMDA, 3.182 g (14 mmol) of DABA, 0.218 g (2 mmol) of MAP, and 30 g of NMP were charged into a 100-mL four-neck flask, and then heated and stirred at 50° C. One hour later, 1.765 g (6 mmol) of BPDA and 0.541 g (5 mmol) of PDA were added, followed by heating and stirring. Two hours later, cooling afforded a varnish.

### Example 5

Under a dry nitrogen gas flow, 3.054 g (14 mmol) of PMDA, 3.182 g (14 mmol) of DABA, 0.218 g (2 mmol) of MAP, and 30 g of NMP were charged into a 100-mL four-neck flask, and then heated and stirred at 50° C. One hour later, 1.765 g (6 mmol) of BPDA and 1.601 g (5 mmol) of TFMB were added, followed by heating and stirring. Two hours later, cooling afforded a varnish.

### Example 6

Under a dry nitrogen gas flow, 3.054 g (14 mmol) of PMDA, 3.182 g (14 mmol) of DABA, 0.218 g (2 mmol) of MAP, and 30 g of NMP were charged into a 100-mL four-neck flask, and then heated and stirred at 50° C. One hour later, 1.765 g (6 mmol) of BPDA and 1.001 g (5 mmol) of DAE were added, followed by heating and stirring. Two hours later, cooling afforded a varnish.

### Example 7

Under a dry nitrogen gas flow, 4.511 g (14 mmol) of BTDA, 3.182 g (14 mmol) of DABA, 0.218 g (2 mmol) of MAP, and 30 g of NMP were charged into a 100-mL four-neck flask, and then heated and stirred at 50° C. One hour later, 1.765 g (6 mmol) of BPDA and 1.136 g (5 mmol) of DABA were added, followed by heating and stirring. Two hours later, cooling afforded a varnish.

### Example 8

Under a dry nitrogen gas flow, 4.511 g (14 mmol) of BTDA, 3.182 g (14 mmol) of DABA, 0.218 g (2 mmol) of MAP, and 30 g of NMP were charged into a 100-mL four-neck flask, and then heated and stirred at 50° C. One hour later, 1.933 g (6 mmol) of BTDA and 0.541 g (5 mmol) of PDA were added, followed by heating and stirring. Two hours later, cooling afforded a varnish.

### Example 9

Under a dry nitrogen gas flow, 3.054 g (14 mmol) of PMDA, 3.182 g (14 mmol) of DABA, 0.092 g (2 mmol) of EtOH, and 30 g of NMP were charged into a 100-mL four-neck flask, and then heated and stirred at 50° C. One hour later, 1.765 g (6 mmol) of BPDA and 1.136 g (5 mmol) of DABA were added, followed by heating and stirring. Two hours later, cooling afforded a varnish.

### Example 10

Under a dry nitrogen gas flow, 3.054 g (14 mmol) of PMDA, 3.182 g (14 mmol) of DABA, 0.218 g (2 mmol) of MAP, and 15 g of NMP were charged into a 100-mL four-neck flask, and then heated and stirred at 50° C. Into another 100-mL four-neck flask were charged 1.765 g (6 mmol) of BPDA, 0.541 g (5 mmol) of PDA, and 15 g of NMP, followed by heating and stirring at 50° C. Two hours later, both were mixed and then heated and stirred. One hour later, cooling afforded a varnish.

### Example 11

Under a dry nitrogen gas flow, 3.054 g (14 mmol) of PMDA, 3.182 g (14 mmol) of DABA, 0.296 g (2 mmol) of PA, and 30 g of NMP were charged into a 100-mL four-neck flask, and then heated and stirred at 50° C. One hour later, 1.471 g (5 mmol) of BPDA and 0.649 g (6 mmol) of PDA were added, followed by heating and stirring. Two hours later, cooling afforded a varnish.

### Example 12

Under a dry nitrogen gas flow, 3.054 g (14 mmol) of PMDA, 3.182 g (14 mmol) of DABA, 0.296 g (2 mmol) of PA, and 15 g of NMP were charged into a 100-mL four-neck flask, and then heated and stirred at 50° C. Into another 100-mL four-neck flask were charged 1.471 g (5 mmol) of BPDA, 0.649 g (6 mmol) of PDA, and 15 g of NMP, followed by heating and stirring at 50° C. Two hours later, both were mixed and then heated and stirred. One hour later, cooling afforded a varnish.

### Example 13

A material resulting from adding 7.06 g (i.e., 30 parts by weight per 100 parts by weight of a polyamic acid resin) of organosilica sol DMAC-ST (produced by Nissan Chemical Industries, Ltd., silica particle concentration: 20%) to 20 g of the varnish obtained in Example 9, followed by stirring, was prepared as a varnish.

### Comparative Example 1

Under a dry nitrogen gas flow, 3.054 g (14 mmol) of PMDA, 1.765 g (6 mmol) of BPDA, 4.318 g (19 mmol) of DABA, 0.218 g (2 mmol) of MAP, and 30 g of NMP were charged into a 100-mL four-neck flask, and then heated and stirred at 50° C. Two hours later, cooling afforded a varnish.

### Comparative Example 2

Under a dry nitrogen gas flow, 3.054 g (14 mmol) of PMDA, 1.861 g (6 mmol) of ODPA, 4.318 g (19 mmol) of DABA, 0.218 g (2 mmol) of MAP, and 30 g of NMP were charged into a 100-mL four-neck flask, and then heated and stirred at 50° C. Two hours later, cooling afforded a varnish.

### Comparative Example 3

Under a dry nitrogen gas flow, 4.362 g (20 mmol) of PMDA, 3.182 g (14 mmol) of DABA, 0.541 g (5 mmol) of PDA, 0.218 g (2 mmol) of MAP, and 30 g of NMP were charged into a 100-mL four-neck flask, and then heated and stirred at 50° C. Two hours later, cooling afforded a varnish.

### Comparative Example 4

Under a dry nitrogen gas flow, 3.054 g (14 mmol) of PMDA, 1.765 g (6 mmol) of BPDA, 3.182 g (14 mmol) of DABA, 0.541 g (5 mmol) of PDA, 0.218 g (2 mmol) of MAP, and 30 g of NMP were charged into a 100-mL four-neck flask, and then heated and stirred at 50° C. Two hours later, cooling afforded a varnish.

### Comparative Example 5

Under a dry nitrogen gas flow, 3.054 g (14 mmol) of PMDA, 1.765 g (6 mmol) of BPDA, 3.182 g (14 mmol) of DABA, 1.601 g (5 mmol) of TFMB, 0.218 g (2 mmol) of MAP, and 30 g of NMP were charged into a 100-mL four-neck flask, and then heated and stirred g at 50° C. Two hours later, cooling afforded a varnish.

### Comparative Example 6

Under a dry nitrogen gas flow, 3.054 g (14 mmol) of PMDA, 1.765 g (6 mmol) of BPDA, 3.182 g (14 mmol) of DABA, 1.001 g (5 mmol) of DAE, 0.218 g (2 mmol) of MAP, and 30 g of NMP were charged into a 100-mL four-neck flask, and then heated and stirred at 50° C. Two hours later, cooling afforded a varnish.

### Comparative Example 7

Under a dry nitrogen gas flow, 4.511 g (14 mmol) of BTDA, 1.765 g (6 mmol) of BPDA, 4.318 g (19 mmol) of DABA, 0.218 g (2 mmol) of MAP, and 30 g of NMP were charged into a 100-mL four-neck flask, and then heated and stirred at 50° C. Two hours later, cooling afforded a varnish.

### Comparative Example 8

Under a dry nitrogen gas flow, 6.445 g (20 mmol) of BTDA, 3.182 g (14 mmol) of DABA, 0.541 g (5 mmol) of PDA, 0.218 g (2 mmol) of MAP, and 30 g of NMP were charged into a 100-mL four-neck flask, and then heated and stirred at 50° C. Two hours later, cooling afforded a varnish.

### Comparative Example 9

Under a dry nitrogen gas flow, 3.054 g (14 mmol) of PMDA, 1.765 g (6 mmol) of BPDA, 4.318 g (19 mmol) of DABA, 0.092 g (2 mmol) of EtOH, and 30 g of NMP were charged into a 100-mL four-neck flask, and then heated and stirred at 50° C. Two hours later, cooling afforded a varnish.

### Comparative Example 10

Under a dry nitrogen gas flow, 3.054 g (14 mmol) of PMDA, 1.471 g (5 mmol) of BPDA, 3.182 g (14 mmol) of DABA, 0.649 g (6 mmol) of PDA, 0.296 g (2 mmol) of PA, and 30 g of NMP were charged into a 100-mL four-neck flask, and then heated and stirred at 50° C. Two hours later, cooling afforded a varnish.

### Comparative Example 11

Under a dry nitrogen gas flow, 1.765 g (6 mmol) of BPDA, 1.364 g (6 mmol) of DABA, 0.218 g (2 mmol) of MAP, and 30 g of NMP were charged into a 100-mL four-neck flask, and then heated and stirred at 50° C. One hour later, 3.054 g (14 mmol) of PMDA and 2.954 g (13 mmol) of DABA were added, followed by heating and stirring. Two hours later, cooling afforded a varnish.

### Comparative Example 12

A material resulting from adding 7.06 g (i.e., 30 parts by weight per 100 parts by weight of a polyamic acid resin) of organosilica sol DMAC-ST (produced by Nissan Chemical Industries, Ltd., silica particle concentration: 20%) to 20 g of the varnish obtained in Comparative Example 9, followed by stirring, was prepared as a varnish.

The compositions of the varnishes synthesized in Examples 1 to 13 and Comparative Examples 1 to 12 are shown in Tables 1 and 2. The result of the storage stability evaluation performed using each of these varnishes and the results of the measurements of the glass transition temperature, coefficient of thermal expansion, and temperature of 5% heat weight loss of a heat-resistant resin film obtained from each of these varnishes are shown in Table 3.

TABLE 1

| | | Resin composition (Each numerical value is the proportion of a monomer) | | | | | | | | | | |
|---|---|---|---|---|---|---|---|---|---|---|---|---|
| | | Blocks A and A′ or C and C′ | | | | | | | Blocks B and B′ or D and D′ | | | |
| | | End alpha or beta | | | Diamine W | Acid dianhydride X | | | Diamine Y | | | |
| | Resin | MAP | EtOH | PA | DABA | PMDA | BTDA | BPDA | DABA | PDA | TFMB | DAE |
| Example 1 | General | 10 | | | 70 | 70 | | | 25 | | | |
| | formula (1) | | | | | | | | | | | |
| Example 2 | General | 10 | | | 70 | 70 | | | 25 | | | |
| | formula (1) | | | | | | | | | | | |
| Example 3 | General | 10 | | | 70 | 70 | | | | 25 | | |
| | formula (1) | | | | | | | | | | | |
| Example 4 | General | 10 | | | 70 | 70 | | | | 25 | | |
| | formula (1) | | | | | | | | | | | |
| Example 5 | General | 10 | | | 70 | 70 | | | | | 25 | |
| | formula (1) | | | | | | | | | | | |
| Example 6 | General | 10 | | | 70 | 70 | | | | | | 25 |
| | formula (1) | | | | | | | | | | | |
| Example 7 | General | 10 | | | 70 | | 70 | | 25 | | | |
| | formula (1) | | | | | | | | | | | |
| Example 8 | General | 10 | | | 70 | | 70 | | | 25 | | |
| | formula (1) | | | | | | | | | | | |
| Example 9 | General | | 10 | | 70 | 70 | | | 25 | | | |
| | formula (1) | | | | | | | | | | | |
| Example 10 | General | 10 | | | 70 | 70 | | | | 25 | | |
| | formula (1) | | | | | | | | | | | |
| Example 11 | General | | | 10 | 70 | 70 | | | | 30 | | |
| | formula (2) | | | | | | | | | | | |
| Example 12 | General | | | 10 | 70 | 70 | | | | 30 | | |
| | formula (2) | | | | | | | | | | | |
| Example 13 | General | | 10 | | 70 | 70 | | | 25 | | | |
| | formula (1) | | | | | | | | | | | |

| | Resin composition | | | | |
|---|---|---|---|---|---|
| | (Each numerical value is | | | | |
| | the proportion of a monomer) | | | | |
| | Blocks B and B′ or D and D′ | | | | |
| | Acid dianhydride Z | | | | |
| | PMDA | BTDA | BPDA | ODPA | Remarks |
| Example 1 | | | 30 | | |
| Example 2 | | | | 30 | |
| Example 3 | 30 | | | | |
| Example 4 | | | 30 | | Synthesis method |
| | | | | | different from that of |
| | | | | | Example 10 |
| Example 5 | | | 30 | | |
| Example 6 | | | 30 | | |
| Example 7 | | | 30 | | |
| Example 8 | | 30 | | | |
| Example 9 | | | 30 | | |
| Example 10 | | | 30 | | Synthesis method |
| | | | | | different from that of |
| | | | | | Example 4 |
| Example 11 | | | 25 | | Synthesis method |
| | | | | | different from that of |
| | | | | | Example 12 |
| Example 12 | | | 25 | | Synthesis method |
| | | | | | different from that of |
| | | | | | Example 11 |
| Example 13 | | | 30 | | Addition of silica |
| | | | | | particles to Example 9 |

TABLE 2

| | Resin composition (Each numerical value is the proportion of a monomer) | | | | | | | | | | | |
|---|---|---|---|---|---|---|---|---|---|---|---|---|
| | End | | | Diamine | | | | Acid dianhydride | | | | |
| | MAP | EtOH | PA | DABA | PDA | TFMB | DAE | PMDA | BTDA | BPDA | ODPA | Remarks |
| Comparative Example 1 | 10 | | | 95 | | | | 70 | | 30 | | Random copolymerization of |
| | | | | | | | | | | | | Example 1 |
| Comparative Example 2 | 10 | | | 95 | | | | 70 | | | 30 | Random copolymerization of |
| | | | | | | | | | | | | Example 2 |
| Comparative Example 3 | 10 | | | 70 | 25 | | | 100 | | | | Random copolymerization of |
| | | | | | | | | | | | | Example 3 |
| Comparative Example 4 | 10 | | | 70 | 25 | | | 70 | | 30 | | Random copolymerization of |
| | | | | | | | | | | | | Examples 4 and 10 |
| Comparative Example 5 | 10 | | | 70 | | 25 | | 70 | | 30 | | Random copolymerization of |
| | | | | | | | | | | | | Example 5 |
| Comparative Example 6 | 10 | | | 70 | | | 25 | 70 | | 30 | | Random copolymerization of |
| | | | | | | | | | | | | Example 6 |
| Comparative Example 7 | 10 | | | 95 | | | | | 70 | 30 | | Random copolymerization of |
| | | | | | | | | | | | | Example 7 |
| Comparative Example 8 | 10 | | | 70 | 25 | | | | 100 | | | Random copolymerization of |
| | | | | | | | | | | | | Example 8 |
| Comparative Example 9 | | 10 | | 95 | | | | 70 | | 30 | | Random copolymerization of |
| | | | | | | | | | | | | Example 9 |
| Comparative Example 10 | | | 10 | 70 | 30 | | | 70 | | 25 | | Random copolymerization of |
| | | | | | | | | | | | | Examples 11 and 12 |
| Comparative Example 11 | 10 | | | 95 | | | | 70 | | 30 | | Interchange of the compositions |
| | | | | | | | | | | | | of blocks A and B of Example 1 |
| Comparative Example 12 | | 10 | | 95 | | | | 70 | | 30 | | Addition of silica particles to |
| | | | | | | | | | | | | Example 9 |

TABLE 3

| | Results of storage stability evaluation | | | | | | | | |
|---|---|---|---|---|---|---|---|---|---|
| | Viscosity | | | Weight average molecular | | | Results of thermal | | |
| | Before | After | Change | | | Change | property evaluation | | |
| | test | test | factor | Before | After | factor | Tg | CTE | Td5 |
| | (mPa · s) | (mPa · s) | (%) | test | test | (%) | (° C.) | (ppm) | (° C.) |
| Example 1 | 2940 | 2440 | 17.0% | 45400 | 43600 | 4.0% | 370 | 5 | 556 |
| Example 2 | 2850 | 2350 | 17.5% | 44800 | 42900 | 4.2% | 372 | 12 | 550 |
| Example 3 | 3010 | 2210 | 26.6% | 43400 | 40600 | 6.5% | 368 | 11 | 566 |
| Example 4 | 2920 | 2590 | 11.3% | 39700 | 38300 | 3.5% | 359 | 6 | 565 |
| Example 5 | 3050 | 2860 | 6.2% | 41200 | 40100 | 2.7% | 369 | 10 | 560 |
| Example 6 | 3000 | 2720 | 9.3% | 43600 | 41800 | 4.1% | 367 | 23 | 554 |
| Example 7 | 3100 | 2880 | 7.1% | 46500 | 44800 | 3.7% | 370 | 14 | 543 |
| Example 8 | 3070 | 2750 | 10.4% | 46000 | 43700 | 5.0% | 366 | 18 | 544 |
| Example 9 | 3040 | 2500 | 17.8% | 47700 | 45900 | 3.8% | 368 | 4 | 560 |
| Example 10 | 3000 | 2680 | 10.7% | 42800 | 41400 | 3.3% | 359 | 7 | 567 |
| Example 11 | 3000 | 2700 | 10.0% | 39500 | 38200 | 3.3% | 356 | 6 | 560 |
| Example 12 | 3020 | 2740 | 9.3% | 43100 | 41800 | 3.0% | 358 | 6 | 562 |
| Example 13 | 3030 | 2550 | 15.8% | — | — | — | 368 | 3 | 571 |
| Comparative Example 1 | 3120 | 1840 | 41.0% | 46000 | 42500 | 7.6% | 369 | 6 | 555 |
| Comparative Example 2 | 3050 | 1660 | 45.6% | 49700 | 46600 | 6.2% | 375 | 12 | 551 |
| Comparative Example 3 | 3080 | 1380 | 55.2% | 43400 | 39200 | 9.7% | 367 | 12 | 567 |
| Comparative Example 4 | 2970 | 1630 | 45.1% | 49500 | 44800 | 9.5% | 354 | 7 | 563 |
| Comparative Example 5 | 2880 | 2120 | 26.4% | 41200 | 39500 | 4.1% | 372 | 12 | 562 |
| Comparative Example 6 | 3030 | 2020 | 33.3% | 43600 | 40600 | 6.9% | 370 | 23 | 557 |
| Comparative Example 7 | 3010 | 2610 | 13.3% | 48700 | 45700 | 6.2% | 368 | 15 | 546 |
| Comparative Example 8 | 2910 | 2350 | 19.2% | 46300 | 42700 | 7.8% | 365 | 19 | 548 |
| Comparative Example 9 | 3090 | 1890 | 38.8% | 48200 | 44800 | 7.1% | 369 | 4 | 557 |
| Comparative Example 10 | 2990 | 1740 | 41.8% | 44100 | 40000 | 9.3% | 357 | 7 | 560 |
| Comparative Example 11 | 3100 | 1690 | 45.5% | 48000 | 44100 | 8.1% | 369 | 6 | 553 |
| Comparative Example 12 | 3000 | 2050 | 31.7% | — | — | — | 370 | 3 | 570 |

### Example 14

### Comparative Example 13

Using the varnishes before the storage stability evaluation of Example 1 and Comparative Example 1, each of the varnishes was spin-coated onto a silicon wafer at 1500 rpm for 30 seconds. Then, prebaked films were obtained by prebaking at 150° C. for 3 minutes. The measurement of the thickness of the prebaked films revealed that the prebaked film (Example 14) obtained from Example 1 had a thickness of 12.0 μm and the prebaked film (Comparative Example 13) obtained from Comparative Example 1 had a thickness of 11.8. Subsequently, films were produced using the varnishes after the storage stability evaluation test. The prebaked film (Example 14) obtained from Example 1 had a thickness of 10.8, whereas the prebaked film (Comparative Example 13) obtained from Comparative Example 1 had a thickness of only 8.8 μm.

### INDUSTRIAL APPLICABILITY

According to the present invention, there can be provided a polyamic acid resin composition which exhibits excellent storage stability and which can afford a thermally treated film having excellent thermal resistance. The thermally treated film can be used suitably for, e.g., flexible substrates of a flat-panel display, electronic paper, a solar battery, and the like; a surface protective coat for a semiconductor device; a dielectric film among layers; an insulation layer or spacer layer of an organic electro-luminescence device (organic EL device); a planarization layer of a thin film transistor substrate; an insulation layer of an organic transistor; a flexible printed circuit board; and a binder for electrodes of a lithium ion secondary battery.

1. A polyamic acid resin composition comprising (a) a polyamic acid represented by the general formula (1) or (2) and (b) one or some solvents,
[Chemical Formula 1]
A-B-A′ (1)
[Chemical Formula 2]
C-D-C′ (2)
wherein in the general formula (1), A and A′ each represent a polyamic acid block represented by the general formula (3) one end of which has been capped; B represents a polyamic acid block represented by the general formula (4); in the general formula (2), C and C′ each represent a polyamic acid block represented by the general formula (5) one end of which has been capped; D represents a polyamic acid block represented by the general formula (6), 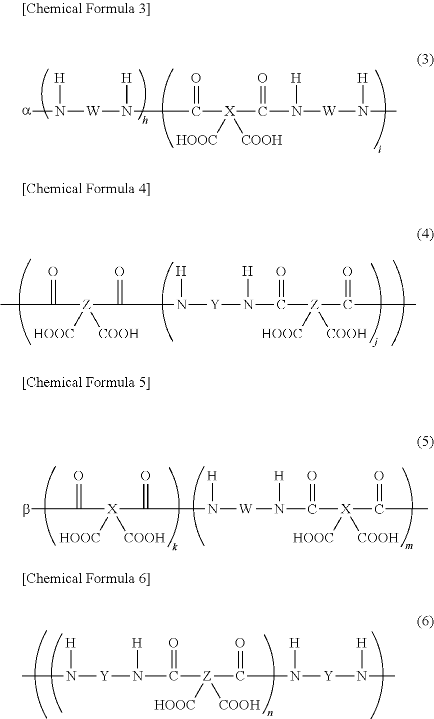
wherein in the general formulae (3) and (5), W is a divalent organic group having 2 or more carbon atoms and contains a divalent organic group represented by the general formula (7) as a main component; X is a tetravalent organic group having 2 or more carbon atoms and contains a tetravalent organic group represented by any one of the general formulae (8) and (9) as a main component; in the general formulae (4) and (6), Y represents a divalent organic group having 2 or more carbon atoms and Z represents a tetravalent organic group having 2 or more carbon atoms, provided that the polyamic acid blocks represented by the general formulae (4) and (6) each exclude polyamic acid blocks having a divalent organic group represented by the general formula (7) as Y and a tetravalent organic group represented by the general formula (8) or (9) as Z; α in the general formula (3) and β in the general formula (5) each represent a monovalent organic group having 1 to 20 carbon atoms; h and k each represent 0 or 1, and i, j, m, and n each represent a positive integer, where the blocks A and A′ may differ in h and in i, and the blocks C and C′ may differ in k and in m, 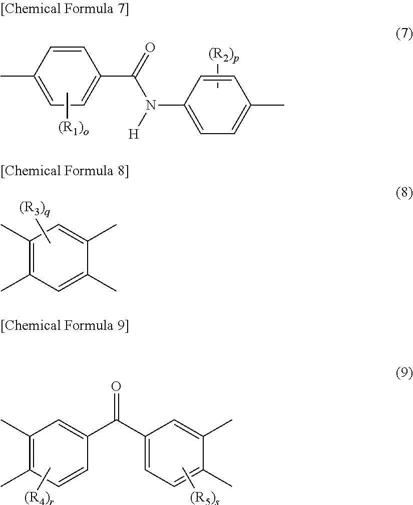
wherein R₁s to R₅s in the general formulae (7) to (9) each may be of a single type or of different types and each represent a monovalent organic group having 1 to 10 carbon atoms; o and p each represent an integer of 0 to 4, q represents an integer of 0 to 2, and r and s each represent an integer of 0 to 3.

2. The polyamic acid resin composition according to claim 1, wherein Z in the general formulae (4) and (6) contains at least a tetravalent organic group represented by the general formula (10) as a main component, 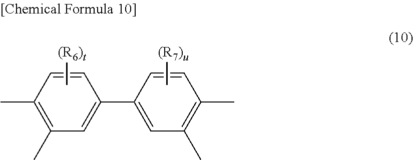
wherein in the general formula (10), R₆s and R₇s each may be of a single type or of different types and each represent a monovalent organic group having 1 to 10 carbon atoms; and t and u each represent an integer of 0 to 3.

3. The polyamic acid resin composition according to claim 1, wherein Y in the general formulae (4) and (6) contains at least a divalent organic group represented by any one of the general formulae (11) and (12) as a main component, 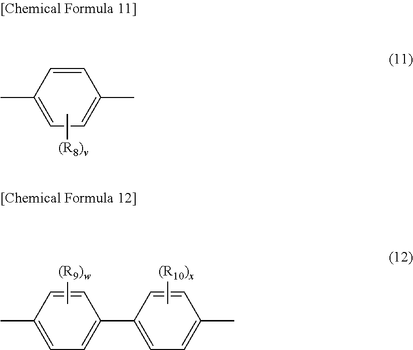
wherein in formulae (11) and (12), R₈s to R₁₀s each may be of a single type or of different types and each represent a monovalent organic group having 1 to 10 carbon atoms; and v, w, and x each represent an integer of 0 to 4.

4. The polyamic acid resin composition according to claim 1, further comprising (c) inorganic particles.

5. A method for producing a polyamic acid resin composition, comprising mixing 1 to 2 molar equivalents of a diamine compound represented by the general formula (14) and 0.01 to 0.5 molar equivalents of an end cap compound with 1 molar equivalent of an acid dianhydride represented by the general formula (13) to react them, and then adding a diamine compound represented by the general formula (15) and an acid dianhydride represented by the general formula (16) in an amount of 1.01 to 2 molar equivalents to 1 molar equivalent of the diamine compound represented by the general formula (15) to react them, wherein a compound other than compounds having Y containing a divalent organic group represented by the general formula (7) is used as the diamine compound represented by the general formula (15) or a compound other than compounds having Z containing a tetravalent organic group represented by any one of the general formulae (8) and (9) is used as the acid dianhydride represented by the general formula (16), 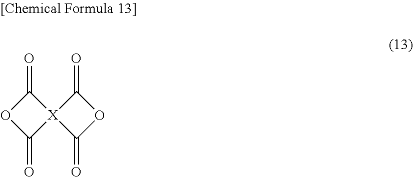
wherein in the general formula (13), X is a tetravalent organic group having 2 or more carbon atoms and contains a tetravalent organic group represented by any one of the general formulae (8) and (9) as a main component,
[Chemical Formula 14]
H₂N—W—NH₂ (14)
wherein in formula (14), W is a divalent organic group having 2 or more carbon atoms and contains a divalent organic group represented by the general formula (7) as a main component,
[Chemical Formula 15]
H₂N—Y—NH₂ (15)
wherein in the general formula (15), Y represents a divalent organic group having 2 or more carbon atoms, 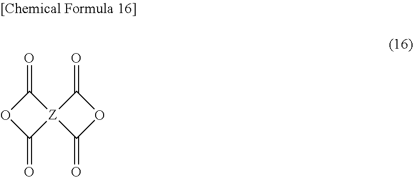
wherein in the general formula (16), Z represents a tetravalent organic group having 2 or more carbon atoms.

6. A method for producing a polyamic acid resin composition, comprising separately preparing a material resulting from mixing 1 to 2 molar equivalents of a diamine compound represented by the general formula (14) and 0.01 to 0.5 molar equivalents of an end cap compound with 1 molar equivalent of an acid dianhydride represented by the general formula (13) to react them, and a material resulting from mixing 1.01 to 2 molar equivalents of an acid dianhydride represented by the general formula (16) with 1 molar equivalent of a diamine compound represented by the general formula (15) to react them, and then mixing both the materials to react with each other, wherein a compound other than compounds having Y containing a divalent organic group represented by the general formula (7) is used as the diamine compound represented by the general formula (15) or a compound other than compounds having Z containing a tetravalent organic group represented by any one of the general formulae (8) and (9) is used as the acid dianhydride represented by the general formula (16), 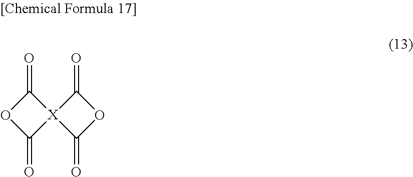
wherein in the general formula (13), X is a tetravalent organic group having 2 or more carbon atoms and contains a tetravalent organic group represented by any one of the general formulae (8) and (9) as a main component,
[Chemical Formula 18]
H₂N—W—NH₂ (14)
wherein in formula (14), W is a divalent organic group having 2 or more carbon atoms and contains a divalent organic group represented by the general formula (7) as a main component,
[Chemical Formula 19]
H₂N—Y—NH₂ (15)
wherein in the general formula (15), Y represents a divalent organic group having 2 or more carbon atoms, 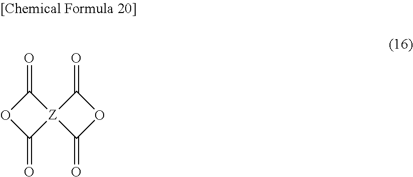
wherein in the general formula (16), Z represents a tetravalent organic group having 2 or more carbon atoms.

7. A method for producing a polyamic acid resin composition, comprising mixing 1 to 2 molar equivalents of an acid dianhydride represented by the general formula (13) and 0.01 to 0.5 molar equivalents of an end cap compound with 1 molar equivalent of a diamine compound represented by the general formula (14) to react them, and then adding an acid dianhydride represented by the general formula (16) and a diamine compound represented by the general formula (15) in an amount of 1.01 to 2 molar equivalents to 1 molar equivalent of the acid dianhydride represented by the general formula (16) to react them, wherein a compound other than compounds having Y containing a divalent organic group represented by the general formula (7) is used as the diamine compound represented by the general formula (15) or a compound other than compounds having Z containing a tetravalent organic group represented by any one of the general formulae (8) and (9) is used as the acid dianhydride represented by the general formula (16), 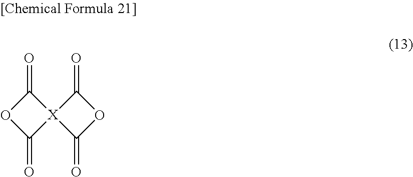
wherein in the general formula (13), X is a tetravalent organic group having 2 or more carbon atoms and contains a tetravalent organic group represented by any one of the general formulae (8) and (9) as a main component,
[Chemical Formula 22]
H₂N—W—NH₂ (14)
wherein in formula (14), W is a divalent organic group having 2 or more carbon atoms and contains a divalent organic group represented by the general formula (7) as a main component,
[Chemical Formula 23]
H₂N—Y—NH₂ (15)
wherein in the general formula (15), Y represents a divalent organic group having 2 or more carbon atoms, 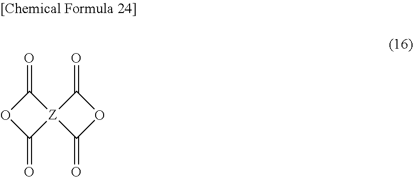
wherein in the general formula (16), Z represents a tetravalent organic group having 2 or more carbon atoms.

8. A method for producing a polyamic acid resin composition, comprising separately preparing a material resulting from mixing 1 to 2 molar equivalents of an acid dianhydride represented by the general formula (13) and 0.01 to 0.5 molar equivalents of an end cap compound with 1 molar equivalent of a diamine compound represented by the general formula (14) to react them, and a material resulting from mixing 1.01 to 2 molar equivalents of a diamine compound represented by the general formula (15) with 1 molar equivalent of an acid dianhydride represented by the general formula (16) to react with each other, and then mixing both the materials to react them, wherein a compound other than compounds having Y containing a divalent organic group represented by the general formula (7) is used as the diamine compound represented by the general formula (15) or a compound other than compounds having Z containing a tetravalent organic group represented by any one of the general formulae (8) and (9) is used as the acid dianhydride represented by the general formula (16), 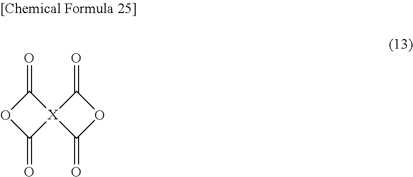
wherein in the general formula (13), X is a tetravalent organic group having 2 or more carbon atoms and contains a tetravalent organic group represented by any one of the general formulae (8) and (9) as a main component,
[Chemical Formula 26]
H₂N—W—NH₂ (14)
wherein in formula (14), W is a divalent organic group having 2 or more carbon atoms and contains a divalent organic group represented by the general formula (7) as a main component,
[Chemical Formula 27]
H₂N—Y—NH₂ (15)
wherein in the general formula (15), Y represents a divalent organic group having 2 or more carbon atoms, 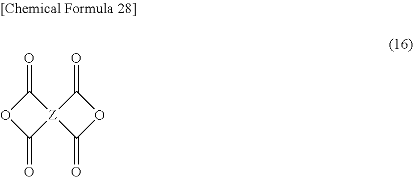
wherein in the general formula (16), Z represents a tetravalent organic group having 2 or more carbon atoms.

9. The polyamic acid resin composition according to claim 2, wherein Y in the general formulae (4) and (6) contains at least a divalent organic group represented by any one of the general formulae (11) and (12) as a main component, 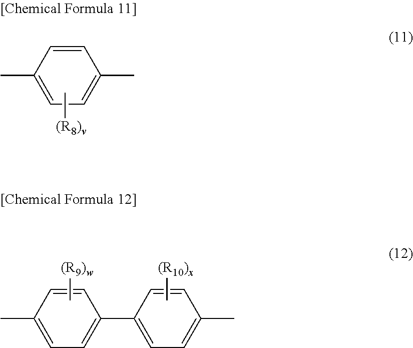
wherein in formulae (11) and (12), R₈s to R₁₀s each may be of a single type or of different types and each represent a monovalent organic group having 1 to 10 carbon atoms; and v, w, and x each represent an integer of 0 to 4.
